(19) United States
(12) Patent Application Publication
(10) Pub. No.: US 2025/0278016 A1
(43) Pub. Date: Sep. 4, 2025

(54) PROJECTOR APPARATUS, STAND-MOUNTED PROJECTOR APPARATUS, AND SUPPORT APPARATUS

(71) Applicant: SEIKO EPSON CORPORATION, Tokyo (JP)

(72) Inventors: Yusaku TAKAMINE, AZUMINO-SHI (JP); Seijiro AOKI, AZUMINO-SHI (JP)

(21) Appl. No.: 19/065,228

(22) Filed: Feb. 27, 2025

(30) Foreign Application Priority Data
Feb. 29, 2024 (JP) 2024-029635

(51) Int. Cl. G03B 21/54; G03B 21/14

(52) U.S. Cl. CPC G03B 21/54; G03B 21/145

(57) ABSTRACT

A projector apparatus includes a table having a penetrating portion, a base coupled to the table so as to be rotatable relatively to the table about a first rotational axis orthogonal to an installation surface on which the table is installed, a coupling unit erected from the base, a projector coupled to the coupling unit, and a stand mounting portion which is disposed on a surface at the installation surface side in the base, located in the penetrating portion and to which a stand is mounted.

The present application is based on, and claims priority from JP Application Serial Number 2024-029635, filed Feb. 29, 2024, the disclosure of which is hereby incorporated by reference herein in its entirety.

### BACKGROUND

### 1. Technical Field

The present disclosure relates to a projector apparatus, a stand-mounted projector apparatus, and a support apparatus.

### 2. Related Art

In the past, there has been known a support base for supporting a projector (see, for example, JP-A-2016-27369).

The support base described in JP-A-2016-27369 includes a stationary portion and a rotary portion. The stationary portion is provided on an opposite side to the projector with respect to the rotary portion, and rotatably supports the rotary portion. The rotary portion includes a pair of projector-support portions which rotatably support the projector. When the rotary portion is rotated with respect to the stationary portion, the projector supported by the projector-support portions of the rotary portion also rotates in accordance with the movement of the rotary portion.

Accordingly, the user can set the projection direction of image light by the projector at will by combining a vertical movement of the projector with left and right movements of the rotary portion.

JP-A-2016-27369 is an example of the related art.

In recent years, applications of a projector are diversified, and there is a demand for a configuration in which a height position of the projector can be adjusted by coupling a stand such as a tripod. To cope with the demand, it is conceivable to provide a configuration in which a stand can be attached to the stationary portion in the support base described in JP-A-2016-27369.

However, when, for example, the stationary portion is attached to an attaching screw of the tripod, it is necessary to rotate the whole of the support base with respect to the tripod, and there is a problem that it is not easy to fix the support base and the tripod to each other. In particular, since the stationary portion rotatably supports the rotary portion that supports the projector relatively heavy in weight, a heavy weight is required for the stationary portion in order to prevent the support base from falling. Therefore, there is a problem that it is not easy to fix the support base to the tripod disposed on the installation surface by rotating the support base including the stationary portion and the projector integrally with each other.

Therefore, there has been a demand for a configuration in which the stand can easily be mounted.

### SUMMARY

A projector apparatus according to a first aspect of the present disclosure includes a table having a penetrating portion, a base coupled to the table so as to be rotatable relatively to the table about a first rotational axis orthogonal to an installation surface on which the table is installed, a coupling unit erected from the base, a projector coupled to the coupling unit, and a stand mounting portion which is disposed on a surface at the installation surface side in the base, located in the penetrating portion and to which a stand is mounted.

A projector apparatus according to a second aspect of the present disclosure includes a table, a base coupled to the table so as to be rotatable relatively to the table about a first rotational axis orthogonal to an installation surface on which the table is installed, a coupling unit erected from the base, and a projector which has a stand mounting portion to which the stand is mounted is disposed on a surface facing the base, and is coupled to the coupling unit, in which the table and the base have a penetrating portion which penetrates the table and the base along the first rotational axis, and through which the stand to be mounted to the stand mounting portion is inserted in a direction along the first rotational axis.

A projector apparatus according to a third aspect of the present disclosure includes a table, a base coupled to the table so as to be rotatable relatively to the table about a first rotational axis orthogonal to an installation surface on which the table is installed, a coupling unit erected from the base, and a projector which has a stand mounting portion to which the stand is mounted, and is coupled to the coupling unit, in which the coupling unit has a hinge configured to make the projector rotatable around a second rotational axis orthogonal to an axis parallel to the first rotational axis, and the table and the base are rotatable about the second rotational axis to positions where the stand mounting portion is exposed toward the installation surface.

A stand-mounted projector apparatus according to a fourth aspect of the present disclosure includes the projector apparatus according to any one of the first to third aspects described above and a stand mounted to the stand mounting portion.

A support apparatus according to a fifth aspect of the present disclosure includes a table having a penetrating portion, a base coupled to the table so as to be rotatable relatively to the table about a rotational axis orthogonal to an installation surface on which the table is installed, a coupling unit erected from the base and configured to be coupled to a projector, and a stand mounting portion which is disposed on a surface at the installation surface side in the base, located in the penetrating portion, and to which a stand is mounted.

A support apparatus according to a sixth aspect of the present disclosure includes a table, a base coupled to the table so as to be rotatable relatively to the table about a rotational axis orthogonal to an installation surface on which the table is installed, and a coupling unit erected from the base and configured to be coupled to a projector including a stand mounting portion to which a stand is mounted, in which the table and the base have a penetrating portion which penetrates the table and the base along the rotational axis, and through which the stand to be mounted to the stand mounting portion is inserted in a direction along the rotational axis.

A support apparatus according to a seventh aspect of the present disclosure includes a table, a base coupled to the table so as to be rotatable relatively to the table about a first rotational axis orthogonal to an installation surface on which the table is installed, and a coupling unit erected from the base and configured to be coupled to a projector including a stand mounting portion to which a stand is mounted, in which the coupling unit has a hinge configured to make the projector rotatable around a second rotational axis orthogonal to an axis parallel to the first rotational axis, and the table and the base are rotatable about the second rotational axis to positions where the stand mounting portion is exposed toward the installation surface.

### BRIEF DESCRIPTION OF THE DRAWINGS

FIG. 1 is a side view showing a stand-mounted projector apparatus according to a first embodiment.

FIG. 2 is a perspective view showing the projector apparatus according to the first embodiment.

FIG. 3 is a perspective view showing the projector apparatus according to the first embodiment.

FIG. 4 is a cross-sectional view showing a support apparatus according to the first embodiment.

FIG. 5 is an exploded perspective view showing the support apparatus according to the first embodiment.

FIG. 6 is an exploded perspective view showing the support apparatus according to the first embodiment.

FIG. 7 is a side view showing a stand-mounted projector apparatus according to a second embodiment.

FIG. 8 is a perspective view showing the projector apparatus according to the second embodiment.

FIG. 9 is a perspective view showing the projector apparatus according to the second embodiment.

FIG. 10 is a bottom view showing the projector apparatus according to the second embodiment.

FIG. 11 is a perspective view showing a projector apparatus of a stand-mounted projector apparatus according to a third embodiment.

FIG. 12 is a perspective view showing a projector apparatus of a stand-mounted projector apparatus according to a fourth embodiment.

### DESCRIPTION OF EMBODIMENTS

### First Embodiment

A first embodiment of the present disclosure will hereinafter be described with reference to the drawings.

### Configuration of Stand-Mounted Projector Apparatus

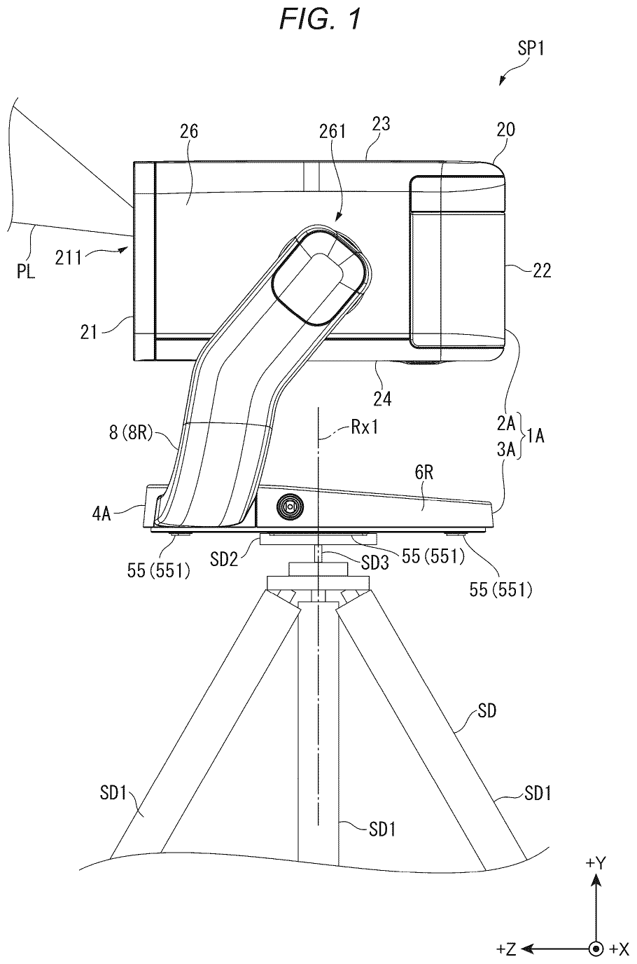

FIG. 1 is a side view showing a stand-mounted projector apparatus SP1 according to the present embodiment.

As illustrated in FIG. 1, the stand-mounted projector apparatus SP1 according to the present embodiment is configured by combining a stand SD and a projector apparatus 1A with each other.

### Configuration of Stand

The stand SD is detachably attached to the projector apparatus 1A as a support target, to support the projector apparatus 1A. In the present embodiment, the stand SD is a tripod that is detachably attached to a support apparatus 3A described later of the projector apparatus 1A, and includes three legs SD1, a camera platform SD2, and a screw part SD3.

Each of the three legs SD1 is configured to be stretchable.

The camera platform SD2 is a part that makes contact with the support target of the stand SD to support the support target.

The screw part SD3 is exposed to the camera platform SD2 and is inserted into the support target. In the present embodiment, the camera platform SD2 makes contact with a first surface 71 of a first support member 7 described later, and then the screw part SD3 is fixed to a stand mounting portion 64 of a base 6A described later, and thus, the stand SD is mounted to the projector apparatus 1A.

### Configuration of Projector Apparatus

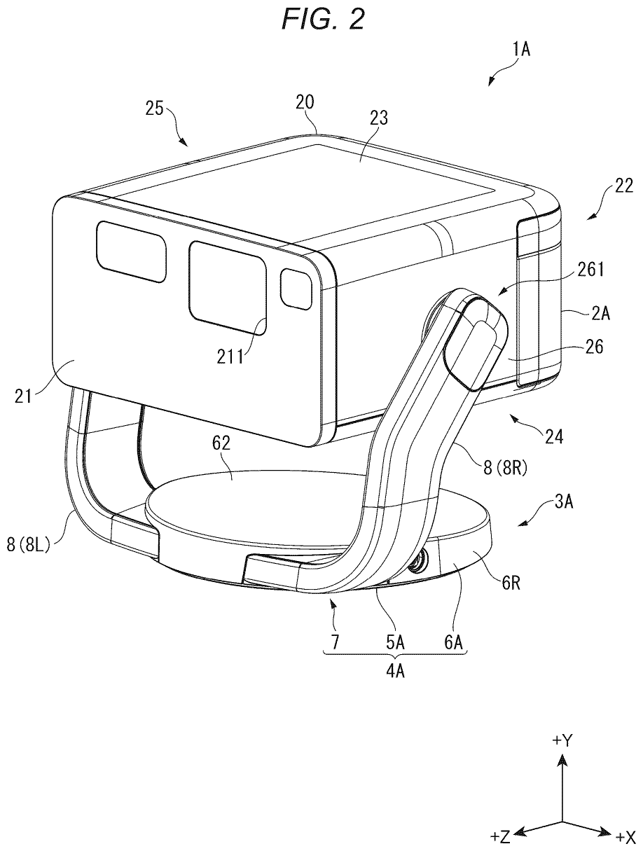

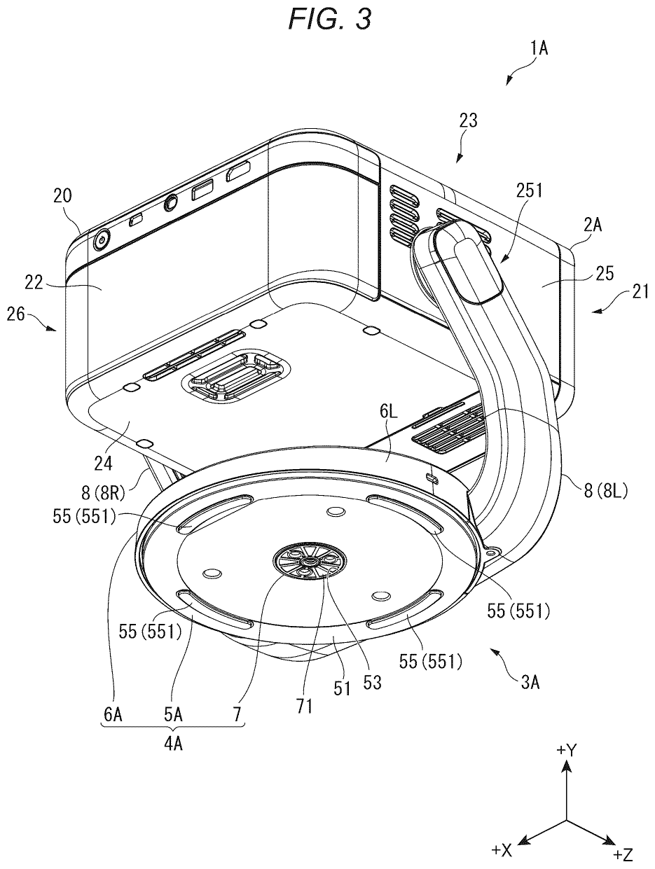

FIG. 2 is a perspective view showing the projector apparatus 1A, and FIG. 3 is a perspective view showing the projector apparatus 1A viewed from an opposite side to the side in FIG. 2.

As illustrated in FIGS. 1 to 3, the projector apparatus 1A includes a projector 2A that projects image light PL and the support apparatus 3A that supports the projector 2A, and is configured by combining the projector 2A and the support apparatus 3A with each other.

### Configuration of Projector

The projector 2A includes an exterior housing 20 which houses an image projection apparatus (not shown).

The exterior housing 20 has a front surface 21, a back surface 22, a top surface 23, a bottom surface 24, a left side surface 25, and a right side surface 26, and is formed in a substantially rectangular parallelepiped shape.

The front surface 21 and the back surface 22 are outer surfaces facing to respective sides opposite to each other in the exterior housing 20. The image light PL projected from the image projection apparatus (not shown) is projected outside the projector 2A through a projection port 211 provided to the front surface 21. The image light PL is projected through the projection port 211 toward the +Z direction described later.

The top surface 23 and the bottom surface 24 are outer surfaces facing to respective sides opposite to each other in the exterior housing 20. The top surface 23 crosses the front surface 21, the back surface 22, the left side surface 25, and the right side surface 26. The bottom surface 24 crosses the front surface 21, the back surface 22, the left side surface 25, and the right side surface 26.

The left side surface 25 and the right side surface 26 are outer surfaces facing to respective sides opposite to each other in the exterior housing 20. The left side surface 25 is provided with an engaging portion 251 to be engaged with an arm 8L described later of the support apparatus 3A, and the right side surface 26 is provided with an engaging portion 261 to be engaged with an arm 8R described later of the support apparatus 3A.

### Configuration of Support Apparatus

The support apparatus 3A rotatably supports the projector 2A, and in addition, is configured so that the stand SD described above is detachably attached to the support apparatus 3A. The support apparatus 3A includes a support apparatus main body 4A having a table 5A, a base 6A, and the support member 7, and a coupling member 8.

Hereinafter, three directions orthogonal to each other are defined as a +X direction, a +Y direction, and a +Z direction. In the present embodiment, a direction in which the projector apparatus 1A vertically gets away from the installation surface when the projector apparatus 1A is installed on the installation surface is defined as a +Y direction. That is, an X-Z plane defined by the +X direction and the +Z direction orthogonal to the +Y direction is a plane parallel to the installation surface. In other words, a direction from the table 5A toward the base 6A along the first rotational axis Rx1 described later is defined as to the +Y direction.

Further, although not shown in the drawings, an opposite direction to the +X direction is defined as a-X direction, an opposite direction to the +Y direction is defined as a-Y direction, and an opposite direction to the +Z direction is defined as a-Z direction. Further, an axis along the +X direction is defined as an X axis, an axis along the +Y direction is defined as a Y axis, and an axis along the +Z direction is defined as a Z axis.

### Configuration of Table

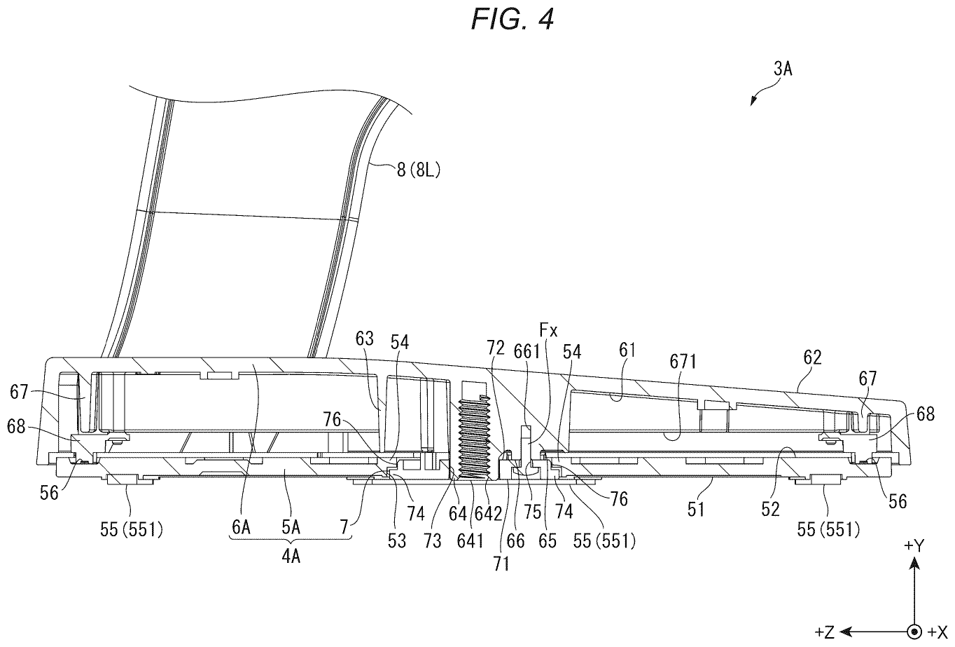

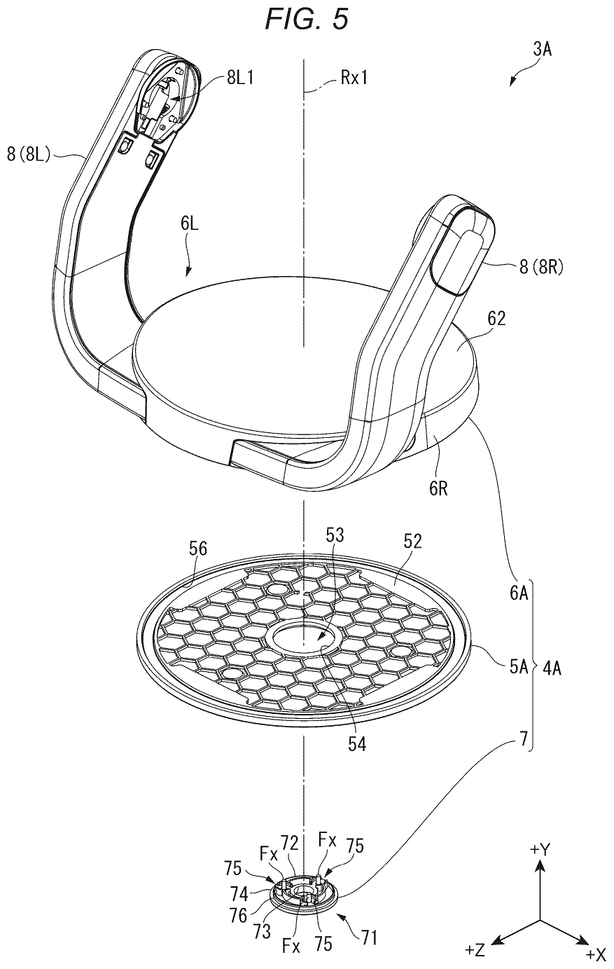

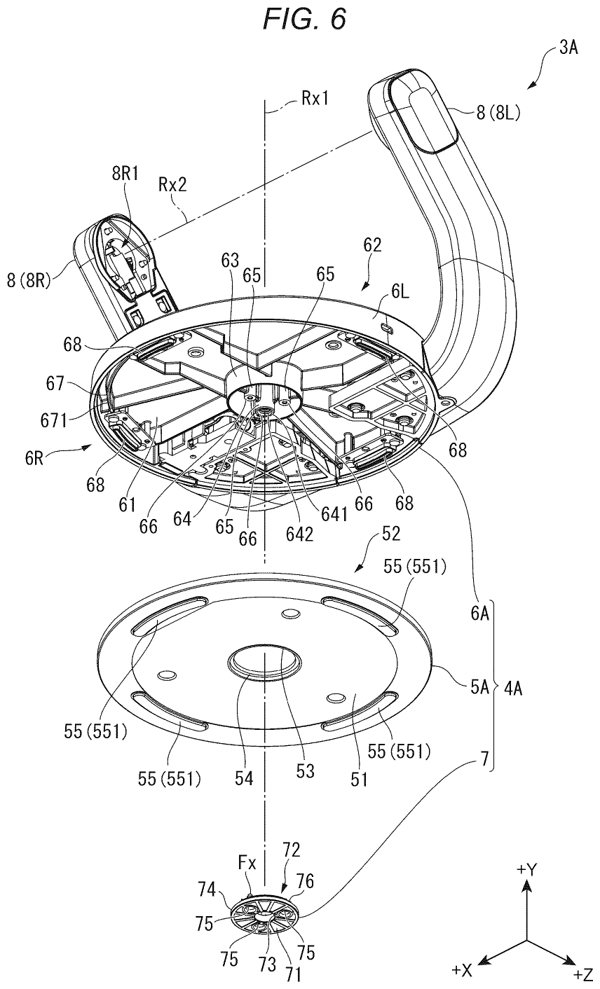

FIG. 4 is a cross-sectional view illustrating the support apparatus 3A. FIG. 5 is an exploded perspective view illustrating the support apparatus 3A viewed from the +Y direction, and FIG. 6 is an exploded perspective view illustrating the support apparatus 3A viewed from the −Y direction.

The table 5A is a portion that comes into contact with the installation surface when the projector apparatus 1A is installed on the installation surface. The table 5A is formed in a circular plate shape, and is configured to be rotatable relatively to the base 6A around a first rotational axis Rx1 along the Y axis when the table 5A is combined with the base 6A and the support member 7.

As illustrated in FIG. 4, the table 5A includes a first surface 51 facing the installation surface and a second surface 52 opposite to the first surface 51 when the projector apparatus 1A is installed on the installation surface. The first surface 51 is a surface facing to the −Y direction, and the second surface 52 is a surface facing to the +Y direction.

As illustrated in FIGS. 4 to 6, the table 5A further includes a penetrating portion 53, a projecting portion 54, installation portions 55, and a recessed portion 56.

The penetrating portion 53 is formed in a circular shape at the center of the table 5A when viewed from the +Y direction or the −Y direction, and is a through opening penetrating the table 5A along the Y axis. Particularly, the penetrating portion 53 surrounds the first rotational axis Rx1 and penetrates the table 5A along the Y axis. In the penetrating portion 53, the stand mounting portion 64 of the base 6A is disposed from the +Y direction, and in addition, the support member 7 is disposed from the −Y direction.

The projecting portion 54 is a portion projecting from the inner edge of the penetrating portion 53 toward the inside of the penetrating portion 53. In other words, the projecting portion 54 is a portion projecting from the inner edge of the penetrating portion 53 toward the center of the penetrating portion 53. Particularly, the projecting portion 54 protrudes from a portion at the +Y direction side in the inner edge of the penetrating portion 53 toward the center of the penetrating portion 53. Therefore, the penetrating portion 53 is a stepped hole in which the diameter of an end edge at the −Y direction side is larger and the diameter of an end edge at the +Y direction side is smaller.

The installation portions 55 are disposed on the first surface 51 and have contact with the installation surface. That is, a surface 551 at the −Y direction side in each of the installation portions 55 is an opposed surface opposed to the installation surface in each of the installation portions 55, and is located at the −Y direction side of the first surface 51.

As illustrated in FIGS. 3 and 6, the installation portions 55 are rubber feet arranged at regular intervals in the circumferential direction around the first rotational axis Rx1 on the first surface 51, and have contact with the installation surface. Note that the number of installation portions 55 is four in the present embodiment, but may be changed as appropriate to any number no smaller than one. Further, the installation portions 55 may be formed in a ring shape along the circumferential direction around the first rotational axis Rx1.

As illustrated in FIGS. 4 and 5, the recessed portion 56 is a recess that is recessed toward the −Y direction from the second surface 52, and is formed in a ring shape centered on the first rotational axis Rx1. When the table 5A and the base 6A are combined with each other, a plurality of guide parts 68 having an arc shape is inserted into the recessed portion 56 from the +Y direction. As a result, the rotation of the base 6A with respect to the table 5A centered on the first rotational axis Rx1 is guided. Note that a lubricant such as grease is preferably applied to the sliding surface of the recessed portion 56 with the guide parts 68. Further, it is possible to adopt a configuration in which a slit is provided to a surface of the guide part 68 facing the recessed portion 56, and the recessed portion 56 has a protruding piece inserted into the slit of the guide part 68.

### Configuration of Base

As illustrated in FIGS. 4 to 6, the base 6A is disposed at the +Y direction side with respect to the table 5A and covers the table 5A in the +Y direction. The base 6A is coupled to the table 5A so as to be rotatable relatively to the table 5A around the first rotational axis Rx1. The base 6A has a first surface 61 facing to the −Y direction, and a second surface 62 facing to the +Y direction and opposite to the first surface 61.

The first surface 61 and the second surface 62 are inclined in a direction in which the closer to the +Z direction side, the further from the table 5A, and the closer to the −Z direction side, the closer to the table 5A. However, this is not a limitation, and the first surface 61 and the second surface 62 may be parallel to at least one of the first surface 51 and the second surface 52 of the table 5A.

Further, the base 6A includes an annular portion 63, the stand mounting portion 64, first protruding portions 65, member receiving surfaces 66, a second protruding portion 67, and the guide parts 68.

As illustrated in FIGS. 4 and 6, the annular portion 63 is a ring-like portion that protrudes from the first surface 61 toward the table 5A and surrounds the periphery of the penetrating portion 53. The annular portion 63 is formed along the circumferential direction around the first rotational axis Rx1.

The stand mounting portion 64, the first protruding portions 65, and the member receiving surfaces 66 are provided inside the annular portion 63. As shown in FIG. 4, when the table 5A and the base 6A are combined with each other, the stand mounting portion 64, the first protruding portions 65, and the member receiving surfaces 66 are located in the penetrating portion 53 when viewed from the −Y direction.

The stand mounting portion 64 is a cylindrical portion protruding in the −Y direction from the first surface 61, and the stand SD can be mounted thereto. That is, the stand mounting portion 64 is disposed on a surface at the installation surface side in the base 6A. The stand mounting portion 64 is located on the first rotational axis Rx1, and the center of a surface 641 facing to the −Y direction in the stand mounting portion 64 crosses the first rotational axis Rx1. The surface 641 is a surface at the installation surface side, and a stand fixing portion 642 is disposed at the center of the surface 641. The stand SD is fixed to the stand fixing portion 642. In the present embodiment, as described above, the stand SD is a tripod, and the stand fixing portion 642 is a screw hole to which the screw part SD3 of the stand SD shown in FIG. 1 is fixed.

The first protruding portions 65 protrude toward the −Y direction from the first surface 61.

The member receiving surfaces 66 are each disposed in a region of a surface at the −Y direction side of the first protruding portion 65, the region being located inside the penetrating portion 53 when viewed from the −Y direction. The member receiving surfaces 66 are each a receiving surface which receives a second surface 72 at the +Y direction side in the support member 7 which is inserted into the penetrating portion 53 from the −Y direction. A member fixing portions 661 to which the support member 7 is fixed are respectively provided to the member receiving surfaces 66.

A fixture Fx for fixing the support member 7 is fixed to the member fixing portion 661, which fixes the support member 7 to the member fixing portions 661 in a state in which the support member 7 is in contact with the member receiving surfaces 66. In the present embodiment, the fixture Fx is a screw, and the member fixing portion 661 is a screw hole into which a tip portion of the fixture Fx having passed through the support member 7 is inserted.

As illustrated in FIGS. 4 and 6, the second protruding portion 67 annularly protrudes along the circumferential direction about the first rotational axis Rx1 from the first surface 61 at a position outside the penetrating portion 53 when viewed from the −Y direction. Particularly, the second protruding portion 67 protrudes toward the −Y direction from the first surface 61 in accordance with the recessed portion 56 provided to the table 5A along the circumferential direction about the first rotational axis Rx1.

A plurality of guide parts 68 is disposed on an end surface 671 at the −Y direction side in the second protruding portion 67. That is, the plurality of guide parts 68 is disposed at positions at regular intervals in the circumferential direction around the first rotational axis Rx1 on the end surface 671. As shown in FIG. 4, the plurality of guide parts 68 is inserted into the recessed portion 56 from the +Y direction when the table 5A and the base 6A are combined with each other. The recessed portion 56 and the guide parts 68 guide a relative rotation about the first rotational axis Rx1 of one of the table 5A and the base 6A with respect to the other thereof.

### Configuration of Support Member

The support member 7 is formed in a circular plate shape and is inserted into the penetrating portion 53 of the table 5A from the −Y direction. The support member 7 faces the projecting portion 54 and is fixed to the base 6A in a state of being in contact with the member receiving surface 66 to thereby make the table 5A rotatable relatively to the base 6A. Specifically, the support member 7 is fixed to the member fixing portions 661 of the base 6A. The support member 7 supports the table 5A together with the base 6A, and in addition, constitutes a stand receiving surface that receives the camera platform SD2 of the stand SD mounted to the stand mounting portion 64 described above.

As illustrated in FIGS. 4 to 6, the support member 7 includes a first surface 71 facing to the −Y direction, and the second surface 72 facing to the +Y direction and opposite to the first surface 71, and in addition, includes a through opening 73, a flange portion 74, and a plurality of insertion openings 75.

The through opening 73 is disposed in a circular shape at the center of the support member 7 when viewed from the −Y direction or the +Y direction, and penetrates the support member 7 in a direction from the first surface 71 toward the second surface 72. That is, the through opening 73 penetrates the support member 7 along the Y axis. The stand mounting portion 64 having a cylindrical shape is inserted into the through opening 73 from the +Y direction. That is, when the table 5A, the base 6A, and the support member 7 are combined with each other, the support member 7 exposes the stand mounting portion 64 at the −Y direction side that is the installation surface side via the through opening 73. On this occasion, the first rotational axis Rx1 along the Y axis is located inside the through opening 73.

The flange portion 74 is a portion protruding outward from a portion at the −Y direction side of a circumferential surface 76 around the first rotational axis Rx1 in the support member 7. Particularly, the flange portion 74 is a portion protruding outward in the radial direction about the first rotational axis Rx1 from a portion at the −Y direction side in the circumferential surface 76, and is formed in a circular shape when viewed from the −Y direction.

A surface at the +Y direction side in the flange portion 74 faces a surface at the −Y direction side in the projecting portion 54 when the support member 7 is disposed inside the penetrating portion 53. When the support member 7 is disposed inside the penetrating portion 53, the flange portion 74 and the projecting portion 54 may be in contact with each other on the Y axis or may be separated from each other.

The plurality of insertion openings 75 is disposed on the periphery f the through opening 73. Particularly, the plurality of insertion openings 75 is arranged at equal intervals along the circumferential direction around the first rotational axis Rx1 outside the through opening 73. In the present embodiment, three insertion openings 75 are disposed, and each of the insertion openings 75 penetrates the support member 7 along the Y axis. The fixture Fx is inserted into each of the plurality of insertion openings 75 from the −Y direction. The support member 7 is fixed to the base 6A by fixing the fixtures Fx which have been inserted through the insertion openings 75 toward the +Y direction to the member fixing portions 661, respectively.

As described above, when the support member 7 is fixed to the member fixing portions 661 of the base 6A so as to sandwich the projecting portion 54 of the table 5A between the support member 7 and the base 6A, the first surface 71 of the support member 7 functions as a second receiving surface that receives the stand SD. That is, the first surface 71 corresponds to a stand receiving surface in the support member 7.

On this occasion, the first surface 71 is located at the +Y direction side of a surface 551 at the −Y direction side in the installation portion 55 of the table 5A on the Y axis along which the first rotational axis Rx1 extends, and the first surface 71 is located at the −Y direction side of the first surface 51 of the table 5A. That is, the first surface 61 corresponding to the second receiving surface is located between the first surface 51 at the installation surface side in the table 5A and the surface 551 at the installation surface side in the installation portion 55 in a direction along the first rotational axis Rx1.

Further, the surface 641 exposed toward the installation surface side in the stand mounting portion 64 of the base 6A disposed inside the through opening 73 of the support member 7 is located at the base 6A side of the surface 551 of the installation portion 55 opposed to the installation surface in the direction along the first rotational axis Rx1. Specifically, the surface 641 at the −Y direction side in the stand mounting portion 64 is located at the +Y direction side of the surface 551 facing to the −Y direction in the installation portion 55 in the direction along the first rotational axis Rx1. Note that the surface 641 corresponds to an exposed surface in the stand mounting portion 64.

### Mounting of Stand to Support Apparatus

When the stand SD is mounted to the support apparatus 3A, as described above, the screw part SD3 is fixed to the stand fixing portion 642 of the stand mounting portion 64 exposed toward the −Y direction in a state in which the camera platform SD2 of the stand SD illustrated in FIG. 1 is in contact with the first surface 71 of the support member 7. Thus, the stand SD is mounted to the support apparatus 3A and, by extension, to the projector apparatus 1A.

### Configuration of Coupling Member

The coupling member 8 is erected from the base 6A of the support apparatus main body 4A and is coupled to the projector 2A. That is, the coupling member constitutes a coupling unit which is coupled to the projector 2A in the base 6A. The coupling member 8 includes a pair of arms 8L, 8R disposed in an end portion at the +Z direction side in the base 6A.

The arm 8L is disposed in a portion at the +Z direction side in a side surface 6L of the base 6A facing to the −X direction, and is coupled to the left side surface 25 of the projector 2A. The arm 8R is disposed in a portion at the +Z direction side in a side surface 6R of the base 6A facing to the +X direction, and is coupled to the right side surface 26 of the projector 2A. The left side surface 25 corresponds to a first surface, and the right side surface 26 corresponds to a second surface.

The arm 8L has a hinge 811 coupled to the left side surface 25 as shown in FIG. 5, and the arm 8R has a hinge 8R1 coupled to the right side surface 26 as shown in FIG. 6. The pair of arms 8L, 8R make the projector 2A rotatable about a second rotational axis Rx2 orthogonal to an axis parallel to the first rotational axis Rx1 via the hinges 8L1, 8R1.

### Advantages of First Embodiment

The stand-mounted projector apparatus SP1 according to the present embodiment described hereinabove exerts the following advantages.

The stand-mounted projector apparatus SP1 includes the projector apparatus 1A and a stand SD mounted to the stand mounting portion 64 provided to the support apparatus 3A of the projector apparatus 1A.

The projector apparatus 1A includes the projector 2A and the support apparatus 3A, and the support apparatus 3A includes the table 5A, the base 6A, and the coupling member 8.

The table 5A includes the penetrating portion 53.

The base 6A is coupled to the table 5A so as to be rotatable relatively to the table about the first rotational axis Rx1 orthogonal to the installation surface on which the table 5A can be installed.

The coupling member 8 corresponds to the coupling unit and is erected from the base 6A.

The projector 2A is coupled to the coupling member 8.

The base 6A has the stand mounting portion 64 which is disposed on the first surface 61 at the installation surface side in the base 6A and on which the stand can be mounted. The stand mounting portion 64 is located in the penetrating portion 53 when the table 5A and the base 6A are combined with each other.

According to such a configuration, when the projector apparatus 1A is attached to a tripod as the stand SD, it is only required to rotate the base 6A with respect to the screw part SD3 as a tripod screw, but it is not necessary to rotate the table 5A. Accordingly, the stand SD and the projector apparatus 1A can easily be fixed to each other.

Further, since the base 6A is rotatable relatively to the table 5A, there is a slight clearance between the base 6A and the table 5A. In this regard, since the stand SD is mounted to the stand mounting portion 64 of the base 6A provided with the coupling member 8 to be coupled to the projector 2A, it is possible to suppress the play of the projector 2A in the projector apparatus 1A to which the stand SD is mounted compared to when the stand SD is mounted to the table 5A. Accordingly, it is possible to prevent the image projected by the projector 2A from shaking.

The projector apparatus 1A includes the projecting portion 54, the member receiving surfaces 66, and the support member 7.

The projecting portion 54 is a portion provided to the table 5A and projecting inside the penetrating portion 53.

The member receiving surfaces 66 correspond to a first receiving surface. The member receiving surfaces 66 are provided to the base 6A and are disposed inside the penetrating portion 53.

The support member 7 faces the projecting portion 54 and is fixed to the base 6A in the state of being in contact with the member receiving surfaces 66. The support member 7 allows the table 5A to rotate relatively to the base 6A. The support member 7 exposes the stand mounting portion 64 toward the −Y direction that is the installation surface side.

According to such a configuration, the table 5A can be sandwiched between the base 6A and the support member 7 to be fixed to the base 6A. This allows the table 5A to be attached to the base 6A so as to be able to rotate relatively to the base 6A. Further, since the support member 7 exposes the stand mounting portion 64, the stand SD can easily be mounted to the stand mounting portion 64.

In the projector apparatus 1A, the first surface 71 at the installation surface side in the support member 7 forms the receiving surface that receives the camera platform SD2 of the stand SD. That is, the first surface 71 constitutes a second receiving surface. The first surface 71 is located closer to the installation surface than the first surface 51 at the installation surface side of the table 5A. That is, the first surface 71 is located at the −Y direction side of the first surface 51.

According to such a configuration, since the receiving surface for receiving the stand SD is formed by the first surface 71 of the support member 7, the contact area between the projector apparatus 1A and the stand SD can be increased. Therefore, it is possible to suppress inclination of the projector apparatus 1A with respect to the stand SD.

Further, when the stand SD is mounted to the first surface 71, the stand SD does not interfere with the table 5A. Therefore, damage to the table 5A due to the contact of the stand SD with the table 5A when the stand SD is mounted can be suppressed.

In the projector apparatus 1A, the table 5A includes an installation portion 55 that can come into contact with the installation surface. The surface 641 exposed to the installation surface side in the stand mounting portion 64 corresponds to an exposed surface, and is located closer to the base 6A than the surface 551 of the installation portion 55 in the +Y direction along the first rotational axis Rx1. That is, the surface 641 is located at the +Y direction side of the surface 551. The surface 551 is an opposed surface that is opposed the installation surface in the installation portion 55.

According to such a configuration, when the projector apparatus 1A is installed on the installation surface with the installation portion 55, it is possible to prevent the stand mounting portion 64 from coming into contact with the installation surface before the installation portion 55 comes into contact with the installation surface. Accordingly, the projector apparatus 1A can stably be installed on the installation surface.

In the projector apparatus 1A, the table 5A includes the installation portion 55 that can come into contact with the installation surface. The first surface 71 as the second receiving surface is located between the first surface 51 at the installation surface side in the table 5A and the surface 551 at the installation surface side in the installation portion 55 in the +Y direction along the first rotational axis Rx1.

According to such a configuration, as described above, when the projector apparatus 1A is installed on the installation surface with the installation portion 55, it is possible to prevent the stand mounting portion 64 from coming into contact with the installation surface before the installation portion 55 comes into contact with the installation surface. Accordingly, the projector apparatus 1A can stably be installed on the installation surface.

Further, the first surface 71 is located at the −Y direction side that is closer to the installation surface than the first surface 51 of the table 5A. Therefore, it is possible to make it easy to make the camera platform SD2 of the stand SD come into contact with the first surface 71. Accordingly, the stand SD can easily be mounted to the projector apparatus 1A.

In the projector apparatus 1A, the stand mounting portion 64 is located on the first rotational axis Rx1.

Here, in the projector apparatus 1A, the first rotational axis Rx1 around which the table 5A and the base 6A can rotate relatively to each other is generally set in consideration of the weight balance of the whole of the projector apparatus 1A. Since the stand mounting portion 64 is disposed on such a first rotational axis Rx1, it is possible to make it easy to maintain the weight balance of the projector apparatus 1A even after the stand SD is mounted.

In the projector apparatus 1A, the projector 2A has the left side surface 25 and the right side surface 26 located at respective sides opposite to each other. One of the left side surface 25 and the right side surface 26 corresponds to the first surface, and the other thereof corresponds to the second surface. The coupling member 8 serving as the coupling unit includes the pair of arms 8L and 8R. The pair of arms 8L, 8R are respectively coupled to the left side surface 25 and the right side surface 26 via the hinges 811, 8R1 that makes the projector 2A rotatable around the second rotational axis Rx2 orthogonal to an axis parallel to the first rotational axis Rx1. Note that in the present embodiment, the second rotational axis Rx2 is orthogonal to the first rotational axis Rx1.

According to such a configuration, it is possible to rotate the projector 2A around the second rotational axis Rx2. As a result, since the rotation of the projector 2A around the first rotational axis Rx1 and the rotation of the projector 2A around the second rotational axis Rx2 can respectively be performed, it is possible to broaden a range of the direction in which the image light can be projected by the projector 2A, and it is possible to enhance the convenience of the projector apparatus 1A.

The support apparatus 3A includes the table 5A, the base 6A, the coupling member 8, and the stand mounting portion 64.

The table 5A includes the penetrating portion 53.

The base 6A is coupled to the table 5A so as to be able to rotate relatively to the table 5A around the first rotational axis Rx1 orthogonal to the installation surface on which the table 5A can be installed.

The coupling member 8 constitutes the coupling unit. The coupling member 8 is erected from the base 6A and configured so that the projector 2A can be coupled to the coupling member 8.

The stand mounting portion 64 is disposed on the first surface 61 at the installation surface side in the base 6A. The stand mounting portion 64 is located in the penetrating portion 53, and the stand SD can be mounted to the stand mounting portion 64.

According to such a configuration, the stand SD and the projector apparatus 1A can easily be fixed to each other.

### Second Embodiment

Then, a second embodiment of the present disclosure will be described.

The stand-mounted projector apparatus according to the present embodiment has substantially the same configuration as that of the stand-mounted projector apparatus according to the first embodiment, but is different in the point that the target to which the stand SD is mounted is the projector, and the point that the support apparatus is provided with the penetrating portion through which the stand is inserted. Note that in the following description, the same or substantially the same portions as the portions having already been described are denoted by the same reference numerals, and the description thereof will be omitted.

### Schematic Configuration of Stand-Mounted Projector Apparatus and Projector Apparatus

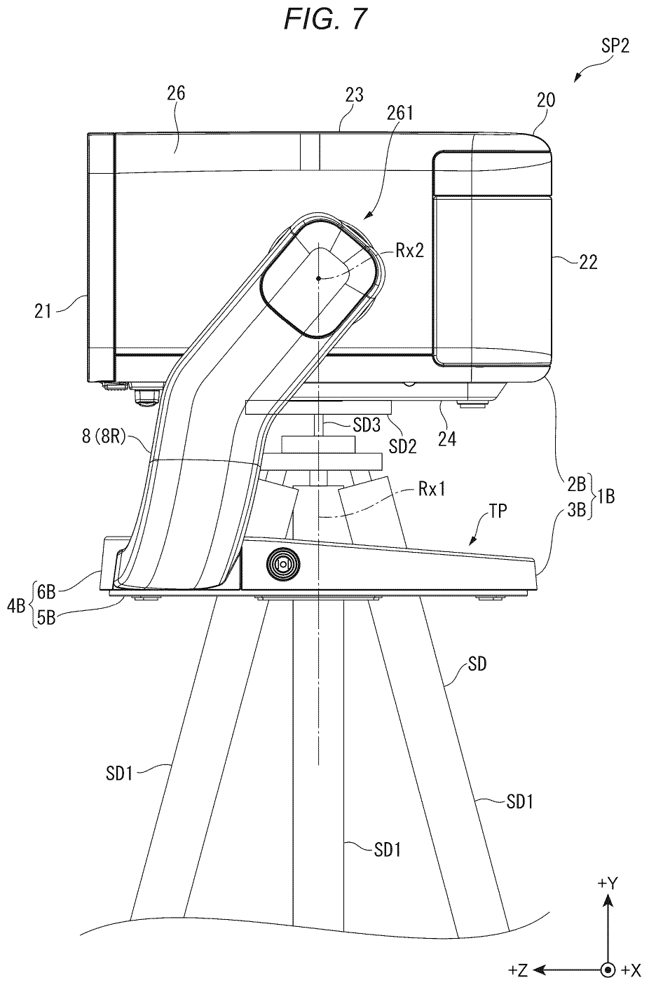

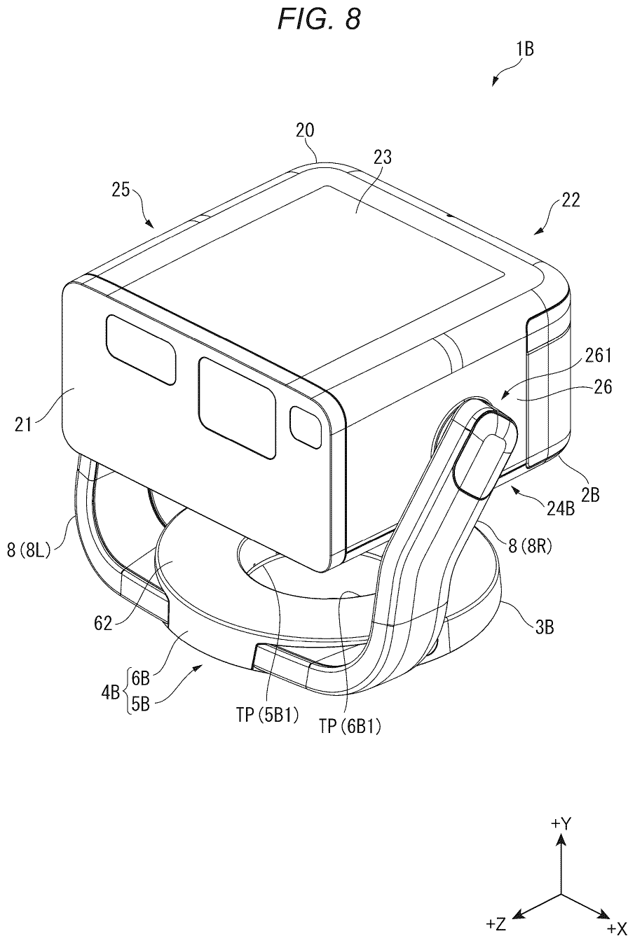

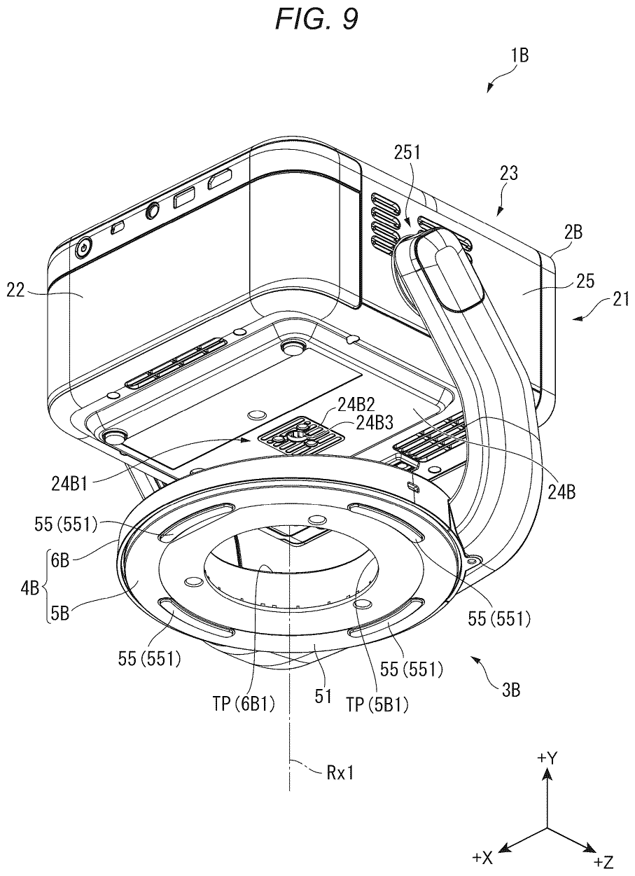

FIG. 7 is a side view showing a stand-mounted projector apparatus SP2 according to the present embodiment. FIG. 8 is a perspective view of a projector apparatus 1B constituting the stand-mounted projector apparatus SP2 viewed from the +Y direction, and FIG. 9 is a perspective view of the projector apparatus 1B viewed from the −Y direction.

The stand-mounted projector apparatus SP2 according to the present embodiment includes substantially the same configuration and function as those of the stand-mounted projector apparatus SP1 according to the first embodiment except that the stand-mounted projector apparatus SP2 includes a projector apparatus 1B instead of the projector apparatus 1A as illustrated in FIG. 7. That is, the stand-mounted projector apparatus SP2 includes the projector apparatus 1B and the stand SD.

As illustrated in FIGS. 7 to 9, the projector apparatus 1B includes a projector 2B and a support apparatus 3B that supports the projector 2B, and has substantially the same function as that of the projector apparatus 1A according to the first embodiment.

### Configuration of Projector

The projector 2B has substantially the same configuration and function as those of the projector 2A except that the projector 2B includes a bottom surface 24B illustrated in FIG. 9 instead of the bottom surface 24. That is, the projector 2B includes the exterior housing 20 having the front surface 21, the back surface 22, the top surface 23, the bottom surface 24B, the left side surface 25, and the right side surface 26.

The bottom surface 24B is a surface facing a base 6B constituting the support apparatus 3B.

The projector 2B further includes a stand mounting portion 24B1.

The stand mounting portion 24B1 is provided to the bottom surface 24B, and the stand SD is mounted to the stand mounting portion 24B1. In the present embodiment, the stand mounting portion 24B1 includes a receiving surface 24B2 that receives the camera platform SD2 of the stand SD, and further includes a stand fixing portion 24B3 which is provided to the receiving surface 24B2 and to which the screw part SD3 of the stand SD is fixed. The camera platform SD2 is in contact with the receiving surface 24B2 and the screw part SD3 is fixed to the stand fixing part 24B3, and thus, the stand SD is mounted to the bottom surface 24B, and by extension, to the projector 2B. That is, in the present embodiment, the bottom surface 24B corresponds to the first receiving surface that receives the stand SD.

Note that the stand mounting portion 24B1 is disposed on the first rotational axis Rx1, and particularly, the stand fixing portion 24B3 is disposed on the first rotational axis Rx1.

### Configuration of Support Apparatus

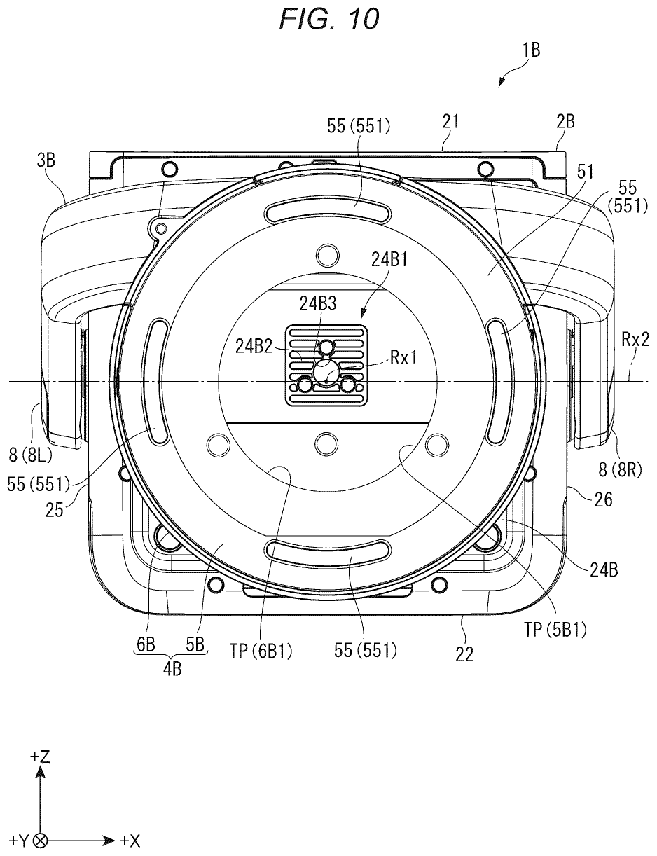

FIG. 10 is a bottom view showing the projector apparatus 1B viewed from the −Y direction.

Similarly to the support apparatus 3A according to the first embodiment, the support apparatus 3B supports the projector 2B so as to be rotatable about the second rotational axis Rx2. The support apparatus 3B includes a support apparatus main body 4B including a table 5B and the base 6B illustrated in FIGS. 7 to 10, and the coupling member 8 provided to the base 6B. That is, the support apparatus 3B according to the present embodiment does not include the support member 7.

### Configuration of Table

Similarly to the table 5A related to the first embodiment, the table 5B is a portion that comes into contact with the installation surface when the projector apparatus 1B is installed on the installation surface. The table 5B is formed in a ring shape when viewed from the −Y direction, and is configured to be rotatable relatively to the base 6B around the first rotational axis Rx1 when the table 5B is combined with the base 6B.

The table 5B has substantially the same configuration and function as those of the table 5A except that the table 5B includes a penetrating portion 5B1 disposed on the first rotational axis Rx1 instead of the penetrating portion 53 and the projecting portion 54. That is, as shown in FIGS. 9 and 10, the table 5B includes the first surface 51, the installation portion 55, and the penetrating portion 5B1, and further includes the second surface 52 and the recessed portion 56 (not shown).

The penetrating portion 5B1 is formed in a circular shape centered on the first rotational axis Rx1, and penetrates the table 5B along the first rotational axis Rx1. A part of the stand SD is inserted into the penetrating portion 5B1 along the Y axis. That is, the stand SD to be mounted to the stand mounting portion 24B1 can be inserted into the penetrating portion 5B1 in the +Y directions along the first rotational axis Rx1. The diameter of such a penetrating portion 5B1 is larger than the diameter of the penetrating portion 53 provided to the table 5A related to the first embodiment.

### Configuration of Base

Similarly to the base 6A related to the first embodiment, the base 6B is disposed at the +Y direction side with respect to the table 5B and covers the table 5B in the +Y direction. The base 6B is disposed to be rotatable relatively to the table 5B about the first rotational axis Rx1.

The base 6B has substantially the same configuration and function as those of the base 6A except that the base 6B includes a penetrating portion 6B1 disposed on the first rotational axis Rx1 instead of the stand mounting portion 64, the first protruding portions 65, and the member receiving surfaces 66. That is, the base 6B includes the first surface 61, the second surface 62, the second protruding portion 67, the guide parts 68, and the penetrating portion 6B1.

The penetrating portion 6B1 is formed in a circular shape centered on the first rotational axis Rx1, and penetrates the base 6B along the first rotational axis Rx1. A part of the stand SD is inserted into the penetrating portion 6B1 along the Y axis. That is, the stand SD to be mounted to the stand mounting portion 24B1 can be inserted into the penetrating portion 6B1 in the +Y directions along the first rotational axis Rx1.

When the base 6B and the table 5B are combined with each other, the penetrating portion 6B1 is coupled to the penetrating portion 5B1, and constitutes an insertion portion TP through which the stand SD is inserted along the Y axis. That is, the support apparatus 3B has the insertion portion TP through which the stand SD is inserted along the Y axis, and the support apparatus 3B is formed in a ring shape centered on the first rotational axis Rx1 except the coupling member 8.

### Mounting of Stand to Projector Apparatus

When the stand SD is mounted to the projector apparatus 1B, the stand SD is inserted into the insertion portion TP from the −Y direction. Subsequently, the screw part SD3 is fixed to the stand fixing portion 24B3 of the stand mounting portion 24B1 in a state in which the camera platform SD2 of the stand SD is in contact with the receiving surface 24B2 which is a part of the bottom surface 24B of the projector 2B. Thus, the stand SD is mounted to the projector 2B, and by extension, to the projector apparatus 1B.

### Advantages of Second Embodiment

The stand-mounted projector apparatus SP2 according to the present embodiment described hereinabove exerts the following advantages.

The projector apparatus 1B includes the projector 2B and the support apparatus 3B, and the support apparatus 3B includes the table 5B, the base 6B, and the coupling member 8.

The table 5B can be installed on the installation surface.

The base 6B is coupled to the table 5B so as to be rotatable relatively to the table 5B about a first rotational axis Rx1 perpendicular to the installation surface.

The coupling member 8 corresponds to the coupling unit and is erected from the base 6B.

The projector 2B has the stand mounting portion 24B1 to which the stand SD can be mounted, on the bottom surface 24B facing the base 6B, and is coupled to the coupling member 8.

The table 5B has the penetrating portion 5B1 that penetrates the table 5B along the first rotational axis Rx1 and through which the stand SD to be mounted to the stand mounting portion 24B1 can be inserted in the +Y directions along the first rotational axis Rx1. The base 6B has the penetrating portion 6B1 that penetrates the base 6B along the first rotational axis Rx1 and through which the stand SD to be mounted to the stand mounting portion 24B1 can be inserted in the +Y directions along the first rotational axis Rx1.

According to such a configuration, the stand SD can be mounted to the stand mounting portion 24B1 provided to the projector 2B through the penetrating portions of the table 5B and the base 6B. Accordingly, since it is possible to make it easy to bring the stand SD into contact with the stand mounting portion 24B1 of the projector 2B, the stand SD can easily be mounted to the projector apparatus 1B.

In addition, since the stand SD is mounted to the stand mounting portion 24B1 provided to the projector 2B, it is possible to prevent the projector 2B from having a play in the projector apparatus 1B to which the stand SD is mounted compared to when the stand SD is mounted to the table 5B. Accordingly, it is possible to prevent the image projected by the projector 2B from shaking.

In the projector apparatus 1B, the penetrating portions 5B1 and 6B1 are located on the first rotational axis Rx1. That is, in the support apparatus main body 4B including the table 5B and the base 6B, the insertion portion TP formed by the penetrating portions 5B1 and 6B1 and penetrating the support apparatus main body 4B along the first rotational axis Rx1 is located on the first rotational axis Rx1.

Here, the first rotational axis Rx1 is generally set in consideration of the weight balance of the whole of the projector apparatus. Since the penetrating portions 5B1, 6B1 are disposed on such a first rotational axis Rx1, the stand SD mounted to the projector 2B can be disposed on the first rotational axis Rx1. Accordingly, it is possible to make it easy to maintain the weight balance of the projector apparatus 1B even after the stand SD is mounted.

The support apparatus 3B includes the table 5B, the base 6B, and the coupling member 8.

The base 6B is coupled to the table 5B so as to be rotatable relatively to the table 5B about the first rotational axis Rx1 orthogonal to the installation surface on which the table 5B can be installed.

The coupling member 8 corresponds to the coupling unit. The coupling member 8 is erected from the base 6B and configured so that the projector 2B having the stand mounting portion 24B1 to which the stand SD can be mounted can be coupled to the coupling member 8.

The table 5B has the penetrating portion 5B1 that penetrates the table 5B along the first rotational axis Rx1 and through which the stand SD to be mounted to the stand mounting portion 24B1 can be inserted in the +Y directions along the first rotational axis Rx1. The base 6B has the penetrating portion 6B1 that penetrates the base 6B along the first rotational axis Rx1 and through which the stand SD to be mounted to the stand mounting portion 24B1 can be inserted in the +Y directions along the first rotational axis Rx1.

According to such a configuration, substantially the same advantages as those of the projector apparatus 1B described above can be exerted.

### Third Embodiment

Then, a third embodiment of the present disclosure will be described.

The stand-mounted projector apparatus according to the embodiment has substantially the same configuration as those of the stand-mounted projector apparatuses SP1, SP2 according to the first and second embodiments. However, the stand-mounted projector apparatus according to the present embodiment is different from the stand-mounted projector apparatuses SP1, SP2 according to the first and second embodiments in that it becomes possible to mount the stand to the projector apparatus by rotating the support apparatus with respect to the projector to expose the stand mounting portion provided to the projector. Note that in the following description, the same or substantially the same portions as the portions having already been described are denoted by the same reference numerals, and the description thereof will be omitted.

### Schematic Configuration of Stand-Mounted Projector Apparatus and Projector Apparatus

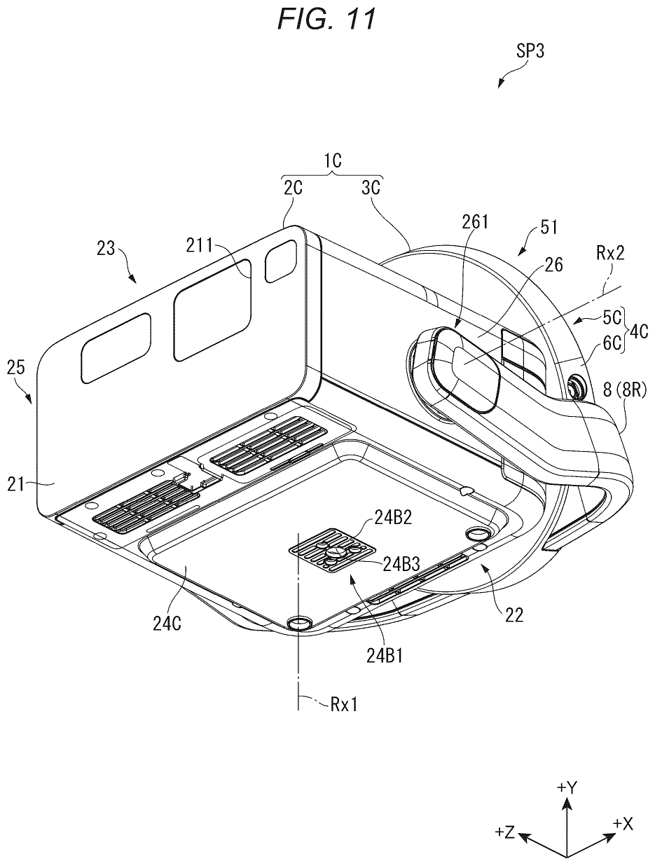

FIG. 11 is a perspective view showing a projector apparatus 1C of a stand-mounted projector apparatus SP3 according to the present embodiment.

The stand-mounted projector apparatus SP3 according to the present embodiment includes the projector apparatus 1C illustrated in FIG. 11 and the stand SD (not illustrated in FIG. 11), and functions similarly to the stand-mounted projector apparatuses SP1, SP2 according to the first and second embodiments.

The stand SD is detachably mounted to the projector apparatus 1C. In the present embodiment, the stand SD is mounted to the projector 2C constituting the projector apparatus 1C.

The projector apparatus 1C includes a projector 2C and a support apparatus 3C that supports the projector 2C, and has substantially the same functions as those of the projector apparatuses 1A, 1B according to the first and second embodiments.

### Configuration of Projector

Similarly to the projectors 2A, 2B according to the first and second embodiments, the projector 2C projects the image light from the projection port 211 provided to the front surface 21. The projector 2C is coupled to the coupling member 8 of the support apparatus 3C.

The projector 2C has the same configuration and function as those of the projectors 2A, 2B according to the first and second embodiments except that the projector 2C includes a bottom surface 24C instead of the bottom surface 24. That is, the projector 2C is coupled to the coupling member 8 of the support apparatus 3C so as to be relatively rotatable about the second rotational axis Rx2 at the left side surface 25 and the right side surface 26.

Similarly to the projector 2B, the projector 2C includes the stand portion 24B1 having the receiving surface 24B2 and the stand fixing portion 24B3. The stand mounting portion 24B1 is provided to the bottom surface 24C, and the stand SD is mounted to the stand mounting portion 24B1.

Note that the position of the stand mounting portion 24B1 on the bottom surface 24C will be described later in detail.

### Configuration of Support Apparatus

The support apparatus 3C includes a support apparatus main body 4C having a table 5C and a base 6C, and the coupling member 8 provided to the base 6C.

The support apparatus main body 4C has substantially the same configuration as that of the support apparatus main body 4A related to the first embodiment or that of the support apparatus main body 4B related to the second embodiment. Alternatively, the support apparatus main body 4C has substantially the same configuration as that of the support apparatus main body 4B without the insertion portion TP.

The table 5C and the base 6C constituting the support apparatus main body 4C have any one of configurations substantially the same as those of the table 5A and the base 6A related to the first embodiment, configurations substantially the same as those of the table 5B and the base 6B related to the second embodiment, and configurations substantially the same as those of the table 5B and the base 6B without the penetrating portions 5B1, 6B1. Note that when the table 5C has substantially the same configuration as that of the table 5A, and the base 6C has substantially the same configuration as that of the base 6A, the support apparatus main body 4C includes the support member 7.

The support apparatus main body 4C is rotatable about the second rotational axis Rx2 by the coupling member 8. Therefore, as shown in FIG. 11, the support apparatus main body 4C can be disposed at a position at the −Z direction side opposite to the projection side of the image light with respect to the projector 2C. That is, the table 5C and the base 6C can arrange the support apparatus main body 4C at a position at the −Z direction side with respect to the projector 2C. In this case, the stand mounting portion 24B1 provided to the bottom surface 24C is exposed toward the −Y direction.

Accordingly, the support apparatus main body 4C can be retracted so that the support apparatus main body 4C does not interfere with the mounting of the stand SD to the stand mounting portion 24B1.

Position of Stand Mounting Portion in Bottom Surface of Projector

In the projector 2C, the stand mounting portion 24B1 is located on the bottom surface 24C at the −Z direction side of the intersection with the first rotational axis Rx1. Particularly, the stand mounting portion 24B1 is positioned at the −Z direction side of an intersection between the first rotational axis Rx1 and the bottom surface 24C when the support apparatus main body 4C is arranged so that the bottom surface 24C faces to the −Y direction and the first surface 51 at the opposite side to the projector 2C in the table 5C faces to the −Y direction.

Therefore, the stand fixing portion 24B3 is disposed at the −Z direction side of the first rotational axis Rx1. That is, when viewed from the position opposed to the bottom surface 24C, the center of the stand mounting portion 24B1 is disposed at the −Z direction side with respect to the intersection in the bottom surface 24C with the first rotational axis Rx1. The −Z direction is a direction at which the table 5C and the base 6C of the support apparatus main body 4C are positioned with respect to the projector 2C when the stand mounting portion 24B1 is exposed toward the −Y direction.

Here, when the base 6C is rotated around the first rotational axis Rx1 with respect to the table 5C in a state before the support apparatus main body 4C is retracted in the −Z direction to change the projection direction of the image light by the projector 2C, it is preferable for the centroid position of the projector apparatus 1C to be located on the first rotational axis Rx1. On the other hand, when the support apparatus main body 4C is retracted in the −Z direction with respect to the projector 2C, the centroid position of the projector apparatus 1C is located at the −Z direction side with respect to the centroid position of the projector apparatus 1C before retracting the support apparatus main body 4C in the −Z direction.

Therefore, the position of the stand mounting portion 24B1 to which the stand SD is mounted is at the −Z direction side with respect to the position of the first rotational axis Rx1 in a state before the support apparatus main body 4C is retracted in the −Z direction. Accordingly, it becomes possible to make it easy to match the position of the stand mounting portion 24B1 with the centroid position of the projector apparatus 1C in a state in which the support apparatus main body 4C is retracted in the −Z direction. Accordingly, the projector apparatus 1C can more stably be supported by the stand SD.

### Advantages of Third Embodiment

The stand-mounted projector apparatus SP3 according to the present embodiment described hereinabove exerts the following advantages.

The projector apparatus 1C includes the projector 2C, the table 5C, the base 6C, and the coupling member 8.

The projector 2C has the stand mounting portion 24B1 to which the stand SD can be mounted. The projector 2C is coupled to the coupling member 8.

The base 6C is coupled to the table 5C so as to be rotatable relatively to the table 5C about the first rotational axis Rx1 orthogonal to the installation surface on which the table 5C can be installed.

The coupling member 8 corresponds to the coupling unit and is erected from the base 6C. The coupling member 8 includes the hinges 8L1, 8R1 that allow the projector 2C to rotate about the second rotational axis Rx2 orthogonal to an axis parallel to the first rotational axis Rx1.

The table 5C and the base 6C are rotatable about the second rotational axis Rx2 to the positions where the stand mounting portion 24B1 can be exposed toward the installation surface. That is, the table 5C and the base 6C are rotatable about the second rotational axis Rx2 to the positions at which the stand mounting portion 24B1 can be exposed toward the installation surface, and which is at the −Z direction side of the projector 2C, the −Z direction being different from the projection direction of the image light.

According to such a configuration, by rotating the table 5C and the base 6C about the second rotational axis Rx2 with the hinges 8L1, 8R1 of the coupling member 8, the stand mounting portion 24B1 provided to the projector 2C can be exposed toward the −Y direction. Therefore, the stand SD can be mounted to the stand mounting portion 24B1 without interfering with the table 5C and the base 6C. Accordingly, it is possible to easily mount the stand SD to the projector apparatus 1C.

In addition, since the stand SD is mounted to the stand mounting portion 24B1 provided to the projector 2C, it is possible to prevent the play of the projector 2C in the projector apparatus 1C to which the stand SD is mounted compared to when the stand SD is mounted to the table 5B. Accordingly, it is possible to prevent the image projected by the projector 2C from shaking.

In the projector apparatus 1C, the center of the stand mounting portion 24B1 is located at the −Z direction side of the first rotational axis Rx1 at which each of the table 5C and the base 6C is located with respect to the projector 2C when the stand mounting portion 24B1 is exposed toward the installation surface.

As described above, the first rotational axis Rx1 is generally set in consideration of the weight balance of the whole of the projector apparatus. Meanwhile, when the table 5C and the base 6C are rotated about the second rotational axis Rx2 to expose the stand mounting portion 24B1, the centroid of the projector apparatus 1C moves toward the −Z direction side at which the table 5C and the base 6C are located with respect to the projector 2C.

In this regard, since the center of the stand mounting portion 24B1 is located at the −Z direction side with respect to the first rotational axis Rx1, it is possible to make it easy to maintain the weight balance of the projector apparatus 1C to which the stand SD is mounted.

The support apparatus 3C includes the table 5C, the base 60, and the coupling member 8.

The base 6C is coupled to the table 5C so as to be rotatable relatively to the table 5C about the first rotational axis Rx1 orthogonal to the installation surface on which the table 5C can be installed.

The coupling member 8 corresponds to a coupling unit, and is erected from the base 6C and configured so that the projector 2C having the stand mounting portion 24B1 to which the stand SD can be mounted can be coupled to the coupling member 8. The coupling member 8 includes the hinges 8L1, 8R1 that allow the projector 2C to rotate about the second rotational axis Rx2 orthogonal to an axis parallel to the first rotational axis Rx1. Note that in the present embodiment, the second rotational axis Rx2 is orthogonal to the first rotational axis Rx1.

The table 5C and the base 6C are rotatable about the second rotational axis Rx2 to the positions where the stand mounting portion 24B1 can be exposed toward the installation surface.

According to such a configuration, substantially the same advantages as those of the projector apparatus 1C described above can be exerted.

### Fourth Embodiment

Then, a fourth embodiment of the present disclosure will be described.

The stand-mounted projector apparatus according to the present embodiment has substantially the same configuration as that of the stand-mounted: projector apparatus SP1 according to the first embodiment, but is different therefrom in that the coupling member includes a position adjustment mechanism capable of adjusting the position of the projector along the Y axis. Note that in the following description, the same or substantially the same portions as the portions having already been described are denoted by the same reference numerals, and the description thereof will be omitted.

### Schematic Configuration of Stand-Mounted Projector Apparatus and Projector Apparatus

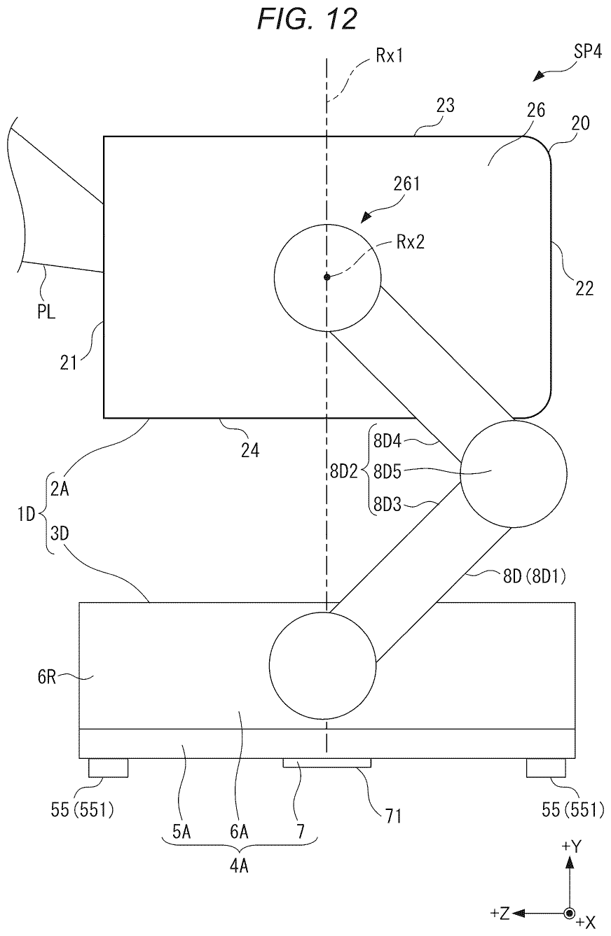

FIG. 12 is a schematic diagram showing a projector apparatus 1D of a stand-mounted projector apparatus SP4 according to the present embodiment.

As illustrated in FIG. 12, the stand-mounted projector apparatus SP4 according to the present embodiment includes the projector apparatus 1D and the stand SD (not illustrated) which can be mounted to the projector apparatus 1D, and has substantially the same function as that of the stand-mounted projector apparatus SP1 according to the first embodiment.

The projector apparatus 1D includes the projector 2A according to the first embodiment and a support apparatus 3D which supports the projector 2A.

### Configuration of Support Apparatus

The support apparatus 3D has substantially the same configuration and function as those of the stand-mounted projector apparatus SP1 according to the first embodiment except that the support apparatus 3D includes a coupling member 8D instead of the coupling member 8. That is, the support apparatus 3D includes the support apparatus main body 4A having the table 5A, the base 6A, and the support member 7, and the coupling member 8D provided to the base 6A.

The coupling member 8D includes a pair of arms 8D1 coupled to the left side surface 25 and the right side surface 26, respectively. One of the pair of arms 8D1 is erected from the side surface 6R of the base 6A and is coupled to the right side surface 26. Although not shown in the drawings, the other of the pair of arms 8D1 is erected from the side surface 6L of the base 6A and is coupled to the left side surface 25. The one arm 8D1 has a hinge 8R1 that enables the projector 2A to rotate about the second rotational axis Rx2 orthogonal to an axis parallel to the first rotational axis Rx1, and the other arm 8D1 has a hinge 8L1 that enables the projector 2A to rotate about the second rotational axis Rx2.

Each of the arms 8D1 includes position adjustment mechanisms 8D2 capable of adjusting the position of the projector 2A in the +Y directions along the first rotational axis Rx1.

The position adjustment mechanism 8D2 includes a first link 8D3 erected from the base 6A, a second link 8D4 coupled to the projector 2A, and a joint 8D5. The joint 8D5 couples the links 8D3, 8D4 to each other so that one of the first link 8D3 and the second link 8D4 can rotate relatively to the other thereof.

Due to such position adjustment mechanisms 8D2, the position of the projector 2A with respect to the support apparatus main body 4A in the +Y directions along the first rotational axis Rx1 can be adjusted.

Note that in the present embodiment, it is assumed that the support apparatus 3D includes the support apparatus main body 4A having the table 5A, the base 6A, and the support member 7. However, the support apparatus 3D may include the support apparatus main body 4B having the table 5B and the base 6B.

Further, it is assumed that the position adjustment mechanism 8D2 provided to each of the arms 8D1 of the coupling member 8D has the two links 8D3, 8D4 and the joint 8D5. However, the number of links provided to the position adjustment mechanism 8D2 may be three or more, and the number of joints 8D5 may appropriately be changed. Further, the position adjustment mechanism 8D2 may be a position adjustment mechanism having a plurality of rods and capable of adjusting the entire length.

Further, it is assumed that the second rotational axis Rx2 is orthogonal to the first rotational axis Rx1. However, the second rotational axis Rx2 is not required to be orthogonal to the first rotational axis Rx1. That is, it is sufficient for the second rotational axis Rx2 to be orthogonal to an axis parallel to the first rotational axis Rx1.

### Advantages of Fourth Embodiment

The stand-mounted projector apparatus SP4 described hereinabove can exert substantially the same advantages as those of the stand-mounted projector apparatuses SP1, SP2, and SP3 according to the first to third embodiments, and in addition, exerts the following advantages.

In the projector apparatus 1D, the coupling member 8D as the coupling unit includes the position adjustment mechanisms 8D2 that adjust the position of the projector in the +Y directions along the first rotational axis Rx1.

According to such a configuration, the projection position of the image light PL by the projector 2A can be adjusted. Accordingly, the convenience of the projector apparatus 1D can be enhanced.

### Modifications of Embodiments

The present disclosure is not limited to each of the embodiments described above, and modifications, improvements, and so on within a range in which the object of the present disclosure can be achieved should fall within the scope of the present disclosure.

In the first to third embodiments, it is assumed that the pair of arms 8L, 8R constituting the coupling member 8 to which the projector 2A, 2B, or 2C is coupled are erected from the base 6A, 6B, or 6C and constitute the coupling unit. In the fourth embodiment described above, it is assumed that the pair of arms 8D1 constituting the coupling member 8D to which the projector 2A is coupled is erected from any one of the bases 6A, 6B to form the coupling unit. However, this is not a limitation, and a pair of arms that support the projector rotatably around the second rotational axis Rx2 may be formed integrally with the base. In addition, the coupling member is not limited to the configuration including the pair of arms, and a configuration including a single arm or three or more arms may be adopted.

In the embodiments described above, it is assumed that the support apparatus 3A, 3B, 3C, or 3D supports the projector 2A, 2B, or 2C rotatably about the second rotational axis Rx2 orthogonal to the Y axis along the first rotational axis Rx1 with the coupling member 8, 8D. However, this is not a limitation, and the coupling unit of the support apparatus configured with the coupling member may be coupled to the projector in a state in which the rotation around the second rotational axis Rx2 is restricted.

In the first embodiment described above, it is assumed that the projecting portion 54 projects toward the inside of the penetrating portion 53 along the circumferential direction around the first rotational axis Rx1. However, this is not a limitation, and a plurality of projecting portions 54 may be provided at, for example, regular intervals along the circumferential direction around the first rotational axis Rx1.

Further, it is sufficient for the base 6A to be coupled to the table 5A rotatably about the first rotational axis Rx1 with respect to the table 5A, and it is not required to sandwich the projecting portion 54 of the table 5A with the base 6A and the support member 7.

In the first embodiment described above, it is assumed that the first surface 71 as the second receiving surface in the support member 7 is located at the +Y direction side of the surface 551 of the installation portion 55 provided to the table 5A, and at the −Y direction side of the first surface 51 of the table 5A. However, this is not a limitation, and the first surface 71 may coincide with an extension surface of the surface 551 of the installation portion 55 or may coincide with an extension surface of the first surface 51 of the table 5A.

In the first embodiment described above, it is assumed that the surface 641 facing to the −Y direction in the stand mounting portion 64 is located at the +Y direction side of the first surface 71 as the second receiving surface in the support member 7. However, this is not a limitation, and the surface 641 may be located at the −Y direction side of the first surface 71. In this case, the surface 641 can be used as the second receiving surface.

In the first and second embodiments described above, it is assumed that the stand mounting portion 64, 24B1 is located on the first rotational axis Rx1. Particularly, it is assumed that the stand fixing portion 642, 24B3 is located on the first rotational axis Rx1. However, this is not a limitation, and the stand mounting portion 64, 24B1 is not required to be located on the first rotational axis Rx1, and the stand fixing portion 642, 24B3 is not required to be located on the first rotational axis Rx1.

In the second embodiment described above, it is assumed that the penetrating portion 5B1 of the table 5B and the penetrating portion 6B1 of the base 6B are located on the first rotational axis Rx1. However, this is not a limitation, and each of the penetrating portions 5B1, 6B1 is not required to be located on the first rotational axis Rx1. That is, the insertion portion TP of the support apparatus main body 4B is not required to be located on the first rotational axis Rx1.

In the third embodiment described above, it is assumed that when the stand mounting portion 24B1 disposed on the bottom surface 24C of the projector 2C is exposed toward the −Y direction, the support apparatus main body 4C having the table 5C and the base 6C is arranged at the −Z direction side with respect to the projector 2C, the −Z direction being opposite to the +Z direction which is the projection direction of the image light. However, this is not a limitation, and the position of the support apparatus main body 4C with respect to the projector 2C can appropriately be changed as long as the support apparatus main body 4C can be disposed at a position where the image light is not shielded. For example, the support apparatus main body 4C may be disposed at the +Y direction side or at the +Z direction side with respect to the projector 2C.

In the third embodiment described above, it is assumed that the stand mounting portion 24B1 is disposed on the bottom surface 24C at the −Z direction side with respect to the intersection with the first rotational axis Rx1. However, this is not a limitation, the stand mounting portion 24B1 may be disposed on the bottom surface 24C such that the stand fixing portion 24B3 is located on the first rotational axis Rx1. Further, the direction in which the stand mounting portion 24B1 is located with respect to the intersection with the first rotational axis Rx1 on the bottom surface 24C can be changed in accordance with the position of the support apparatus main body 4C having the table 5C and the base 6C with respect to the projector 2C.

In each of the embodiments described above, it is assumed that the exterior housing 20 provided to the projector 2A, 2B, or 2C is formed in a substantially rectangular parallelepiped shape. However, this is not a limitation, and for example, the projector 2A, 2B, or 2C may include an exterior housing in which the left side surface 25 and the right side surface 26 coupled to the coupling member 8, 8D are formed in a convexly curved surface shape.

In each of the embodiments described above, it is assumed that the stand SD is a tripod having the camera platform SD2 and the screw part SD3. However, this is not a limitation, and the configuration of the stand SD is not limited to the above as long as the stand SD supports the projector apparatus 1A, 1B, 1C, or 1D.

### Summary of Present Disclosure

The present disclosure will be summarized below as additional remarks.

### Additional Remark 1

A projector apparatus including
a table having a penetrating portion,
a base coupled to the table so as to be rotatable relatively to the table about a first rotational axis orthogonal to an installation surface on which the table is installed,
a coupling unit erected from the base,
a projector coupled to the coupling unit, and
a stand mounting portion which is disposed on a surface at the installation surface side in the base, located in the penetrating portion and to which a stand is mounted.

According to such a configuration, the stand is mounted to the stand mounting portion provided to the base. Therefore, when the projector apparatus is attached to a tripod as the stand, it is only required to rotate the base with respect to a screw, but it is not necessary to rotate the table. Accordingly, the stand and the projector apparatus can easily be fixed to each other.

Further, since the base is rotatable relatively to the table, there is a slight clearance between the base and the table. In this regard, since the stand is mounted to the stand mounting portion of the base provided with the coupling unit to be coupled to the projector, it is possible to suppress the play of the projector in the projector apparatus to which the stand is mounted compared to when the stand is mounted to the table. Accordingly, it is possible to prevent the image projected by the projector from shaking.

### Additional Remark 2

The projector apparatus described in Additional Remark 1, further including
a projecting portion that is provided to the table, and projects toward an inner side of the penetrating portion,
a first receiving surface that is provided to the base, and is disposed inside the penetrating portion, and
a support member that faces the projecting portion and is fixed to the base in a state of being in contact with the first receiving surface, and is configured to make the table rotatable relatively to the base, in which
the support member is configured to expose the stand mounting portion.

According to such a configuration, the table can be sandwiched between the base and the support member to be fixed to the base. This allows the table to be attached to the base so as to be able to rotate relatively to the base. Further, since the support member exposes the stand mounting portion, the stand can easily be mounted to the stand mounting portion.

### Additional Remark 3

The projector apparatus described in Additional Remark 2, in which
a surface at the installation surface side in the support member forms a second receiving surface configured to receive the stand, and
the second receiving surface is located closer to the installation surface than a surface at the installation surface side in the table.

According to such a configuration, since the support member forms the second receiving surface, the contact area between the projector apparatus and the stand can be increased. Therefore, it is possible to suppress inclination of the projector apparatus with respect to the stand.

Further, when the stand is mounted to the second receiving surface, the stand does not interfere with the table. Therefore, damage to the table due to the contact of the stand with the table when the stand is mounted can be suppressed.

### Additional Remark 4

The projector apparatus described in any one of Additional Remarks 1 to 3, in which
the table has an installation portion configured to come into contact with the installation surface, and
an exposed surface exposed toward the installation surface side in the stand mounting portion is located closer to the base than an opposed surface of the installation portion opposed to the installation surface in a direction along the first rotational axis.

According to such a configuration, when the projector apparatus is installed on the installation surface with the installation portion, it is possible to prevent the stand mounting portion from coming into contact with the installation surface before the installation portion comes into contact with the installation surface. Accordingly, the projector apparatus can stably be installed on the installation surface.

### Additional Remark 5

The projector apparatus described in Additional Remark 3, in which
the table has an installation portion configured to come into contact with the installation surface, and
the second receiving surface is located between a surface at the installation surface side in the table and a surface at the installation surface side in the installation portion in a direction along the first rotational axis.

According to such a configuration, when the projector apparatus is installed on the installation surface with the installation portion, it is possible to prevent the stand mounting portion from coming into contact with the installation surface before the installation portion comes into contact with the installation surface. Accordingly, the projector apparatus can stably be installed on the installation surface.

Further, the second receiving surface is located closer to the installation surface than the surface at the installation surface side in the table. Therefore, it is possible to make it easy to bring the stand into contact with the second receiving surface. Accordingly, it is possible to easily mount the stand.

### Additional Remark 6

The projector apparatus described in any one of Additional Remarks 1 to 5, in which
the stand mounting portion is located on the first rotational axis.

Here, in the projector apparatus, the first rotational axis around which the table and the base can rotate relatively to each other is generally set in consideration of the weight balance of the whole of the projector apparatus. Since the stand mounting portion is disposed on such a first rotational axis, it is possible to make it easy to maintain the weight balance of the projector apparatus even after the stand is mounted.

### Additional Remark 7

A projector apparatus including
a table,
a base coupled to the table so as to be rotatable relatively to the table about a first rotational axis orthogonal to an installation surface on which the table is installed,
a coupling unit erected from the base, and
a projector which has a stand mounting portion to which the stand is mounted is disposed on a surface facing the base, and is coupled to the coupling unit, in which
the table and the base have a penetrating portion which penetrates the table and the base along the first rotational axis, and through which the stand to be mounted to the stand mounting portion is inserted in a direction along the first rotational axis.

According to such a configuration, the stand can be mounted to the stand mounting portion provided to the projector through the penetrating portions of the table and the base. Accordingly, since it is possible to make it easy to bring the stand into contact with the stand mounting portion of the projector constituting the projector apparatus, the stand can easily be mounted to the projector apparatus.

In addition, since the stand is mounted to the stand mounting portion provided to the projector, it is possible to prevent the play of the projector in the projector apparatus to which the stand is mounted compared to when the stand is mounted to the table. Accordingly, it is possible to prevent the image projected by the projector from shaking.

### Additional Remark 8

The projector apparatus described in Additional Remark 7, in which
the penetrating portion is located on the first rotational axis.

As described above, the first rotational axis is generally set in consideration of the weight balance of the whole of the projector apparatus. Since the penetrating portions are disposed on such a first rotational axis, the stand mounted to the projector can be disposed on the first rotational axis. Accordingly, it is possible to make it easy to maintain the weight balance of the projector apparatus even after the stand is mounted.

### Additional Remark 9

A projector apparatus including
a table,
a base coupled to the table so as to be rotatable relatively to the table about a first rotational axis orthogonal to an installation surface on which the table is installed,
a coupling unit erected from the base, and
a projector which has a stand mounting portion to which the stand is mounted, and is coupled to the coupling unit, in which
the coupling unit has a hinge configured to make the projector rotatable around a second rotational axis orthogonal to an axis parallel to the first rotational axis, and
the table and the base are rotatable about the second rotational axis to positions where the stand mounting portion is exposed toward the installation surface.

According to such a configuration, by rotating the table and the base about the second rotational axis with the hinge of the coupling unit, the stand mounting portion provided to the projector can be exposed. Therefore, the stand can be mounted to the stand mounting portion without interfering with the table and the base. Accordingly, it is possible to easily mount the stand to the projector apparatus.

In addition, since the stand is mounted to the stand mounting portion provided to the projector, it is possible to prevent the play of the projector in the projector apparatus to which the stand is mounted compared to when the stand is mounted to the table. Accordingly, it is possible to prevent the image projected by the projector from shaking.

### Additional Remark 10

The projector apparatus described in Additional Remark 9, in which
a center of the stand mounting portion is located in a direction side, at which the table and the base are located with respect to the projector when the stand mounting portion is exposed toward the installation surface, of the first rotational axis.

As described above, the first rotational axis is generally set in consideration of the weight balance of the whole of the projector apparatus. Meanwhile, when the table and the base are rotated about the second rotational axis to expose the stand mounting portion, the centroid of the projector apparatus moves toward the direction side at which the table and the base are located with respect to the projector.

In this regard, since the center of the stand mounting portion is located at the direction side described above with respect to the first rotational axis, it is possible to make it easy to maintain the weight balance of the projector apparatus to which the stand is mounted.

### Additional Remark 11

The projector apparatus described in any one of Additional Remarks 1 to 10, in which
the projector includes a first surface and a second surface located at respective sides opposite to each other, and
the coupling unit includes a pair of arms coupled respectively to the first surface and the second surface via a hinge configured to make the projector rotatable about a second rotational axis orthogonal to an axis parallel to the first rotational axis.

According to such a configuration, it is possible to rotate the projector about the second rotational axis orthogonal to an axis parallel to the first rotational axis. As a result, since the rotation of the projector around the first rotational axis and the rotation of the projector around the second rotational axis can respectively be performed, it is possible to broaden a range of the direction in which the image light can be projected by the projector, and it is possible to enhance the convenience of the projector apparatus.

### Additional Remark 12

The projector apparatus according to any one of Additional Remarks 1 to 11, in which
the coupling unit includes a position adjustment mechanism configured to adjust a position of the projector in a direction along the first rotational axis.

According to such a configuration, the projection position of the image light by the projector can be adjusted. Accordingly, the convenience of the projector apparatus can be enhanced.

### Additional Remark 13

A stand-mounted projector apparatus including
the projector apparatus described in any one of Additional Remarks 1 to 12; and
a stand mounted to the stand mounting portion.

According to such a configuration, substantially the same advantages as those of the projector apparatus described above can be exerted.

### Additional Remark 14

A support apparatus including
a table having a penetrating portion,
a base coupled to the table so as to be rotatable relatively to the table about a rotational axis orthogonal to an installation surface on which the table is installed,
a coupling unit erected from the base and configured to be coupled to a projector, and
a stand mounting portion which is disposed on a surface at the installation surface side in the base, located in the penetrating portion, and to which a stand is mounted.

According to such a configuration, substantially the same advantages as those of the projector apparatus according to Additional Remark 1 described above can be exerted.

### Additional Remark 15

A support apparatus including
a table,
a base coupled to the table so as to be rotatable relatively to the table about a rotational axis orthogonal to an installation surface on which the table is installed, and
a coupling unit erected from the base and configured to be coupled to a projector including a stand mounting portion to which a stand is mounted, in which
the table and the base have a penetrating portion which penetrates the table and the base along the rotational axis, and through which the stand to be mounted to the stand mounting portion is inserted in a direction along the rotational axis.

According to such a configuration, substantially the same advantages as those of the projector apparatus according to Additional Remark 7 described above can be exerted.

### Additional Remark 16

A support apparatus including
a table,
a base coupled to the table so as to be rotatable relatively to the table about a first rotational axis orthogonal to an installation surface on which the table is installed, and
a coupling unit erected from the base and configured to be coupled to a projector including a stand mounting portion to which a stand is mounted, in which
the coupling unit has a hinge configured to make the projector rotatable around a second rotational axis orthogonal to an axis parallel to the first rotational axis, and
the table and the base are rotatable about the second rotational axis to positions where the stand mounting portion is exposed toward the installation surface.

According to such a configuration, substantially the same advantages as those of the projector apparatus according to Additional Remark 9 described above can be exerted.

What is claimed is:

1. A projector apparatus comprising:
a table having a penetrating portion;
a base coupled to the table so as to be rotatable relatively to the table about a first rotational axis orthogonal to an installation surface on which the table is installed;
a coupling unit erected from the base;
a projector coupled to the coupling unit; and
a stand mounting portion which is disposed on a surface at the installation surface side in the base, located in the penetrating portion and to which a stand is mounted.

2. The projector apparatus according to claim 1, further comprising:
a projecting portion that is provided to the table, and projects toward an inner side of the penetrating portion;
a first receiving surface that is provided to the base, and is disposed inside the penetrating portion; and
a support member that faces the projecting portion and is fixed to the base in a state of being in contact with the first receiving surface, and is configured to make the table rotatable relatively to the base, wherein
the support member is configured to expose the stand mounting portion.

3. The projector apparatus according to claim 2,
wherein a surface at the installation surface side in the support member forms a second receiving surface configured to receive the stand, and
the second receiving surface is located closer to the installation surface than a surface at the installation surface side in the table.

4. The projector apparatus according to claim 1, wherein
the table has an installation portion configured to come into contact with the installation surface, and
an exposed surface exposed toward the installation surface side in the stand mounting portion is located closer to the base than an opposed surface of the installation portion opposed to the installation surface in a direction along the first rotational axis.

5. The projector apparatus according to claim 3, wherein
the table has an installation portion configured to come into contact with the installation surface, and
the second receiving surface is located between a surface at the installation surface side in the table and a surface at the installation surface side in the installation portion in a direction along the first rotational axis.

6. The projector apparatus according to claim 1, wherein
the stand mounting portion is located on the first rotational axis.

7. A projector apparatus comprising:
a table;
a base coupled to the table so as to be rotatable relatively to the table about a first rotational axis orthogonal to an installation surface on which the table is installed;
a coupling unit erected from the base; and
a projector which has a stand mounting portion to which the stand is mounted is disposed on a surface facing the base, and is coupled to the coupling unit, wherein
the table and the base have a penetrating portion which penetrates the table and the base along the first rotational axis, and through which the stand to be mounted to the stand mounting portion is inserted in a direction along the first rotational axis.

8. The projector apparatus according to claim 7, wherein
the penetrating portion is located on the first rotational axis.

9. A projector apparatus comprising:
a table;
a base coupled to the table so as to be rotatable relatively to the table about a first rotational axis orthogonal to an installation surface on which the table is installed;
a coupling unit erected from the base; and
a projector which has a stand mounting portion to which the stand is mounted, and is coupled to the coupling unit, wherein
the coupling unit has a hinge configured to make the projector rotatable around a second rotational axis orthogonal to an axis parallel to the first rotational axis, and
the table and the base are rotatable about the second rotational axis to positions where the stand mounting portion is exposed toward the installation surface.

10. The projector apparatus according to claim 9, wherein
a center of the stand mounting portion is located in a direction side, at which the table and the base are located with respect to the projector when the stand mounting portion is exposed toward the installation surface, of the first rotational axis.

11. The projector apparatus according to claim 1, wherein
the projector includes a first surface and a second surface located at respective sides opposite to each other, and
the coupling unit includes a pair of arms coupled respectively to the first surface and the second surface via a hinge configured to make the projector rotatable about a second rotational axis orthogonal to an axis parallel to the first rotational axis.

12. The projector apparatus according to claim 1, wherein
the coupling unit includes a position adjustment mechanism configured to adjust a position of the projector in a direction along the first rotational axis.

13. A stand-mounted projector apparatus comprising:
the projector apparatus according to claim 1; and
a stand mounted to the stand mounting portion.

14. A support apparatus comprising:
a table having a penetrating portion;
a base coupled to the table so as to be rotatable relatively to the table about a rotational axis orthogonal to an installation surface on which the table is installed;
a coupling unit erected from the base and configured to be coupled to a projector; and
a stand mounting portion which is disposed on a surface at the installation surface side in the base, located in the penetrating portion, and to which a stand is mounted.

15. A support apparatus comprising:
a table;
a base coupled to the table so as to be rotatable relatively to the table about a rotational axis orthogonal to an installation surface on which the table is installed; and
a coupling unit erected from the base and configured to be coupled to a projector including a stand mounting portion to which a stand is mounted, wherein
the table and the base have a penetrating portion which penetrates the table and the base along the rotational axis, and through which the stand to be mounted to the stand mounting portion is inserted in a direction along the rotational axis.

16. A support apparatus comprising:
a table;
a base coupled to the table so as to be rotatable relatively to the table about a first rotational axis orthogonal to an installation surface on which the table is installed; and
a coupling unit erected from the base and configured to be coupled to a projector including a stand mounting portion to which a stand is mounted, wherein
the coupling unit has a hinge configured to make the projector rotatable around a second rotational axis orthogonal to an axis parallel to the first rotational axis, and
the table and the base are rotatable about the second rotational axis to positions where the stand mounting portion is exposed toward the installation surface.
